(19) United States
(12) Patent Application Publication
(10) Pub. No.: US 2024/0068116 A1
(43) Pub. Date: Feb. 29, 2024

(54) MICROPOROUS ASYMMETRIC ORGANIC/INORGANIC COMPOSITE MEMBRANE

(71) Applicant: UOP LLC, Des Plaines, IL (US)

(72) Inventors: Xueliang Dong, Schaumburg, IL (US); Chunqing Liu, Arlington Heights, IL (US); Nicole Karns, Des Plaines, IL (US)

(21) Appl. No.: 18/319,762

(22) Filed: May 18, 2023

Related U.S. Application Data
(60) Provisional application No. 63/374,030, filed on Aug. 31, 2022.

(51) Int. Cl. C25B 13/02; C25B 13/08

(52) U.S. Cl. CPC C25B 13/02; C25B 13/08; C25B 1/04

(57) ABSTRACT

A porous ion-permeable separator membrane with an asymmetric pore structure in which the top of the membrane (the side opposite the porous substrate) has smaller pores than the pores in the rest of the polymer coating (i.e., closer to the porous substrate) is described. The porous ion-permeable asymmetric composite membrane comprises polymers, inorganic particles, and a porous substrate which is stable at a pH of 8 or higher.

### RELATED APPLICATIONS

This application claims priority to U.S. Provisional Patent Application Ser. No. 63/374,030 filed on Aug. 31, 2022, the entirety of which is incorporated herein by reference.

### BACKGROUND

Hydrogen as an energy vector for grid balancing or power-to-gas and power-to-liquid processes plays an important role in the path toward a low-carbon energy structure that is environmentally friendly. Water electrolysis produces high quality hydrogen by electrochemical splitting of water into hydrogen and oxygen; the reaction is given by Eq. 1 below. The water electrolysis process is an endothermic process and electricity is the energy source. Water electrolysis has zero carbon footprint when the process is operated by renewable power sources, such as wind, solar, or geothermal energy. The main commercially available water electrolysis technologies include alkaline water electrolysis (AEL), and proton exchange membrane (PEM) water electrolysis (PEMWE as shown in FIG. 1).

As shown in FIG. 1, in a PEMWE system 100, an anode 105 and a cathode 110 are separated by a solid PEM electrolyte 115 such as a sulfonated tetrafluoroethylene based cofluoropolymer sold under the trademark Nafion® by Chemours company. The anode and cathode catalysts typically comprise IrO₂ and Pt, respectively. At the positively charged anode 105, pure water 120 is oxidized to produce oxygen gas 125, electrons (e⁻), and protons; the reaction is given by Eq. 2. The protons are transported from the anode 105 to the cathode 110 through the PEM 115 that conducts protons. At the negatively charged cathode 110, a reduction reaction takes place with electrons from the cathode 110 being given to protons to form hydrogen gas 130; the reaction is given by Eq. 3. The PEM 115 not only conducts protons from the anode 105 to the cathode 110, but also separates the H₂ gas 130 and O₂ gas 125 produced in the water electrolysis reaction. PEM water electrolysis is one of the favorable methods for conversion of renewable energy to high purity hydrogen with the advantage of compact system design at high differential pressures, high current density, high efficiency, fast response, small footprint, lower temperature (20-90° C.) operation, and high purity oxygen byproduct. However, one of the major challenges for PEMWE is the high capital cost of the cell stack comprising expensive acid-tolerant stack hardware such as the Pt-coated Ti bipolar plates, expensive noble metal catalysts required for the electrodes, as well as the expensive PEM.

Water electrolysis reaction: 2H₂O→2H₂+O₂ (1)

Oxidation reaction at anode for PEMWE: 2H₂O→O₂+4H⁺+4e⁻ (2)

Reduction reaction at cathode for PEMWE: 2H⁺+2e⁻→H₂ (3)

AEL will likely remain the dominant electrolysis technology in the long-term, especially for large scale hydrogen production (gigawatt scale) as a result of using lower cost materials, such as steel and nickel, rather than expensive platinum and iridium.

In recent years, development of AEL technology has intensified to further optimize the components, improve the efficiency, and reduce the cost of the AEL system. In addition to new electrocatalysts, the focus has become the development and optimization of other cell components, especially the separators. The separator is a porous barrier placed between the electrodes to prevent the direct mixing of the product gases inside the electrolysis cell. Asbestos was used first as a diaphragm in the water electrolysis cell until this material was banned due to health concerns. Polysulfone (PSU) and polyphenylene sulfide (PPS) have been selected as promising new materials to replace asbestos. However, these polymers are slightly hydrophobic, and the wettability by the electrolyte solution (25-30 wt % KOH) is low, resulting in high ionic resistance. Therefore, hydrophilic materials like inorganic particles or other polymers have been added to improve the overall wettability. The composite materials showed improved chemical and mechanical stability and electrolyte wettability. A typical example is Zirfon™ porous composite separator composed of a polysulfone matrix and zirconium dioxide (ZrO₂). Currently, Zirfon™ separator membranes manufactured by Agfa are the most well-known separators used for AEL.

For this type of composite separator membrane, the overall performance is strongly dependent on the detailed microstructure and chemical composition. Zrifon™ separator membranes have a symmetric structure which increases the ionic transport resistance.

Therefore, development of new separator membranes with optimized pore structure and with more hydrophilic materials is desired.

### BRIEF DESCRIPTION OF THE DRAWINGS

FIG. 1 is an illustration of one embodiment of a PEMWE cell.

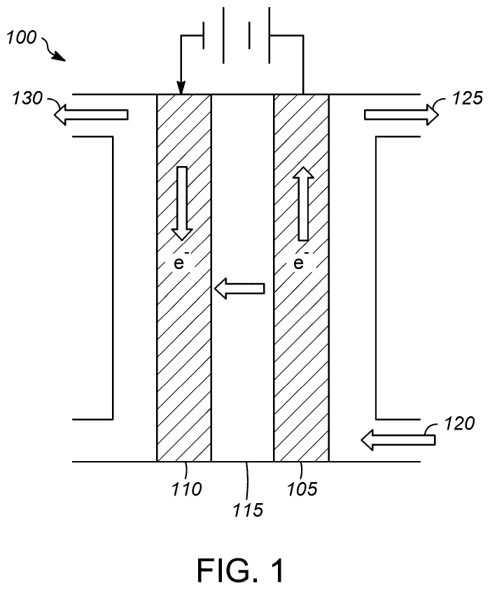

FIG. 2 is a cross-sectional HRSEM image of the membrane prepared in Example 4.

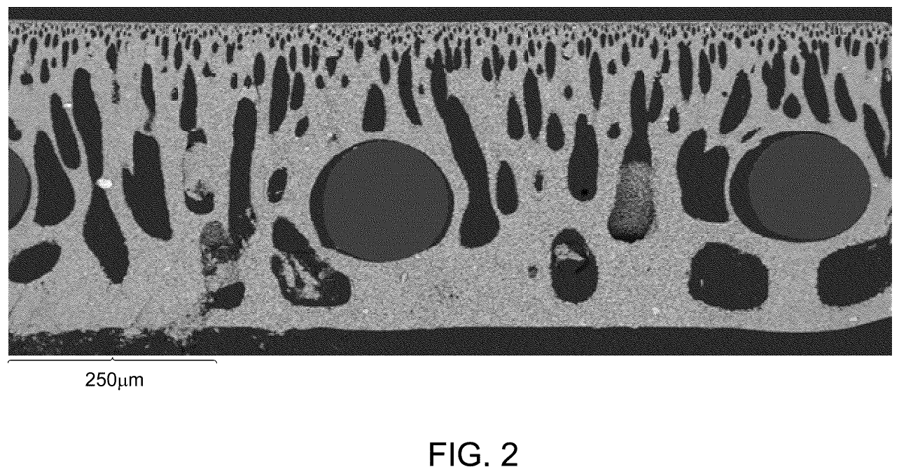

### DESCRIPTION OF THE INVENTION

A new type of porous ion-permeable separator membrane with an asymmetric pore structure and a more hydrophilic polymer coating has been developed for alkaline water electrolysis applications. The separator membrane has high pH stability at pH of 8 or more, bubble point of 1 bar or more, porosity of 40% or more, and low ionic resistance of 350 mΩ·cm² or less. The porous ion-permeable asymmetric composite membrane transports the hydroxide ions (OH⁻) from the cathode to the anode in the presence of an aqueous alkaline solution in the alkaline water electrolyzer, and prevents the mixing of the produced hydrogen and oxygen at the cathode and anode, respectively. The porous ion-permeable asymmetric composite membrane comprises a porous substrate and a porous asymmetric polymer coating. The polymer coating has an asymmetric pore distribution with pores having a first size adjacent to the porous substrate and pores having a size smaller than the first size adjacent to the second side (i.e., the pores on top (the side opposite the porous substrate) are smaller than the pores in the rest of the polymer coating). The polymer coating comprises a polymer and inorganic particles. The polymers, inorganic particles, and porous substrate are stable at a pH of 8 or more.

The polymer coating has an asymmetric structure. The top of the membrane (the side opposite the porous substrate) has smaller pores than the pores in the rest of the polymer coating (i.e., closer to the porous substrate).

The polymer coating should have high mechanical strength with high pressure resistance up to 100 bar, good thermal stability up to at least 150° C., high pH stability at pH 8 or higher, and be hydrophilic. Suitable polymers include, but are not limited to, polyether sulfone (PES), polysulfone (PSU), polyvinylidene fluoride (PVDF), or combinations thereof. In some embodiments, PES is used because it has higher mechanical and thermal performance, and higher chemical resistance than PSU. Moreover, PES has a more polar moiety, making it slightly more hydrophilic, which is useful in separator membrane materials for AEL. PES also showed high stability in high concentration KOH solution at 80° C.

There are inorganic particles in the polymer coating. Suitable inorganic particles include, but are not limited to, zirconium oxide, iron oxide, nickel oxide, cobalt oxide, copper oxide, manganese oxide, molybdenum oxide, titanium oxide, antimony oxide, or combinations thereof. In some embodiments, the inorganic particles comprise zirconium oxide, antimony oxide, or a mixture thereof. The inorganic particles may comprise 10 wt % to 90 wt % of the polymer coating, or 20 wt % to 90 wt %, or 30 wt % to 90 wt %, or 40 wt % to 90 wt %, or 50 wt % to 90 wt %, or 60 wt % to 90 wt %. The particle size is not particularly limited because the membrane is porous; however, the size should be selected so that the particles do not precipitate out of the solution easily.

The membrane is fabricated on a porous substrate to improve the mechanical strength. The porous substrate may comprise polyphenylene sulfide, poly(ether ether ketone), polytetrafluoroethylene, polyethylene, polypropylene, copolymer of tetrafluoroethylene and ethylene, copolymer of tetrafluoroethylene and propylene, copolymer of ethylene and propylene, polychlorotrifluoroethylene, or combinations thereof. In some embodiments, the porous substrate comprises polyphenylene sulfide or poly(ether ether ketone).

In some embodiments, the porous substrate has an air permeance of 0.5 ft³/ft²/min or more. In some embodiments, the porous substrate has an open area of 20% to 90%, or 30% to 90%, or 40% to 90%, or 50% to 90%, or 60% to 90%.

In some embodiments, the polymer in the polymer coating is different from that of the porous substrate.

The asymmetric structure provides low ionic resistance. The pore sizes and pore distribution of this membrane are controllable by changing the fabrication parameters, such as the concentration of polymers, the amount of inorganic particles, the non-solvent, and the temperature of the coagulation bath.

In one embodiment, the composite membrane comprises a PES matrix, ZrO₂ nano powders, and a PPS porous substrate. This combination has the advantages of low cost, high stability under AEL operation conditions, and high ionic conductivity. As a result, the separator membrane can improve the AEL efficiency and reduce the cost.

Another aspect of the invention is method of making a porous ion-permeable asymmetric composite membrane. In one embodiment, the method comprises mixing a polymer, inorganic particles, and a solvent, and the polymer and the inorganic particles being stable at a pH of 8 or higher to form a membrane casting dope; casting the membrane casting dope on a porous substrate to form a polymer coating on the porous substrate, the polymer coating having an asymmetric pore distribution with pores having a first size adjacent to the porous substrate and pores having a size smaller than the first size adjacent to the second side, the porous substrate being stable at a pH of 8 or higher, the polymer coating on the porous substrate forming a wet membrane; and annealing the wet membrane to form the stable porous ion-permeable asymmetric composite membrane. In some embodiments, the wet porous ion-permeable asymmetric composite membrane is dried at 50° C. to 150° C., or 50° C. 140 to 120° C., or 60° C. to 90° C.

A uniform casting dope is formed by mixing the polymers, inorganic particles, and solvents. Suitable solvents include, but are not limited to, N-methyl-2-pyrrolidone (NMP), dimethylacetamide (DMAc), dimethylformamide (DMF), dimethyl sulfoxide (DMSO), 1,3-dioxolane, acetone, methanol, ethanol, tetrahydrofuran (THF), toluene, n-octane, n-decane, lactic acid, citric acid, isopropanol, or mixtures thereof.

Suitable casting process include, but are not limited to, the phase inversion process via knife casting or Mayer rod casting, slot die coating, dip coating, meniscus coating, gravure coating, or combinations thereof.

In some embodiments, the solvent may be removed from the polymer coating and the porous substrate before annealing the wet membrane. In addition to removing the solvent, this can also solidify the wet membrane. Suitable solvent removal processes include, but are not limited to, water wash and/or solvent exchange.

The wet membrane is annealed to stabilize the pore structure of the membrane. Suitable annealing processes include, but are not limited to, annealing the wet membrane in hot water at a temperature in a range of 50° C. to 90° C., or 65 to 90° C.

The annealed wet membrane can be dried. Suitable drying processes include, but are not limited to, a direct air drying method at 50 to 100° C., or 60 to 90° C., or other suitable drying process.

Another aspect of the invention is the use of the porous ion-permeable asymmetric composite membrane for AEL. In one embodiment, the AEL cell comprises: a porous ion-permeable asymmetric composite membrane as described above; an anode comprising an anode catalyst on a first surface of the porous ion-permeable asymmetric composite membrane; and a cathode comprising a cathode catalyst on a second surface of the porous ion-permeable asymmetric composite membrane. An alkaline solution, such as a KOH solution, is introduced to both the cathode and the anode. Water is split at the cathode to form H₂ and release hydroxide anions (OH⁻) which cross through the microporous membrane and combine to form O₂ at the anode.

The anode and the cathode catalysts are for oxygen evolution reaction and hydrogen evolution reaction, respectively. The anode and the cathode catalysts should have low cost and good electrocatalytic activity and stability. Suitable cathode catalysts can be selected from, but are not limited to, Ni, Ni—C, Ni-based alloys such as Ni—Mo, Ni—Al, Ni—Cr, Ni—Sn, Ni—Co, Ni—W, and Ni—Al—Mo, metal carbides such as Mo₂C, metal phosphides such as CoP, metal dichalcogenides such as MoSe₂, high surface area Ni catalysts from dealloying of Ni-based alloys such as Nickel-Zn and Ni—Al, and mixtures thereof. Suitable anode catalysts can be selected from, but are not limited to, Ni—Fe, Ni—Mo, Ni—Co—Fe, spinel CuₓCo₃ₓO₃, Ni—Fe layered double hydroxide nanoplates on carbon nanotubes, immobilized metal catalyst on conductive supports, and mixtures thereof.

In some embodiments, the anode comprising an anode catalyst on a first surface of the porous ion-permeable asymmetric composite membrane is formed by coating an anode catalyst ink on the first surface of the porous ion-permeable asymmetric composite membrane via meniscus coating, knife coating, spray coating, painting, or other known conventional ink coating technologies, followed by drying the coated a porous ion-permeable asymmetric composite membrane.

In some embodiments, the cathode comprising a cathode catalyst on a second surface of the porous ion-permeable asymmetric composite membrane is formed by coating a cathode catalyst ink on the second surface of the porous ion-permeable asymmetric composite membrane via meniscus coating, knife coating, spray coating, painting, or other known conventional ink coating technologies, followed by drying the coated a porous ion-permeable asymmetric composite membrane.

In some embodiments, the anode catalyst ink comprises the anode catalyst, an OH⁻ exchange ionomer as a binder, and a solvent. In some embodiments, the cathode catalyst ink comprises the cathode catalyst, an OH⁻ exchange ionomer as a binder, and a solvent. The OH⁻ exchange ionomer binder creates OH⁻ transport pathways between the membrane and the reaction sites within the electrodes and thus drastically improves the utilization of the electrocatalyst particles while reducing the internal resistance. The OH⁻ exchange ionomer binder can have a chemical structure similar to the anion exchange polymer described above, so that the binder will allow low interfacial resistance and similar expansion in contact with water to avoid catalyst delamination, but OH⁻ conductivity and high oxygen and hydrogen permeance. The solvent can be selected from, but is not limited to, water, alcohol, or a mixture thereof.

In some embodiments, the anode and the cathode are not coated on the surfaces of the porous ion-permeable asymmetric composite membrane.

### EXAMPLES

### Example 1

In a glass jar, 57 g Zirconium oxide (ZrO₂) nanopowder (E101, Luxfer MEL Technologies) was mixed with 45.6 g N-Methyl-2-pyrrolidone (NMP, Millipore Sigma) using an overhead mixer for 30 min. After the ZrO₂ powders were fully wetted in NMP, a first batch of 3 g polyether sulfone (PES, BASF Corporation) was added and stirred for 1 h. The glass jar was placed in a sonication bath and sonicated for 10 min. A second batch of 4 g PES was then added, stirred for 1 h and sonicated for 10 min. A third batch of 3 g PES was then added, stirred for 1 h and sonicated for 10 min. Finally, 3 g polyvinylpyrrolidone (PVP, Fisher Scientific) was added and stirred for 1 h. The weight ratio of PES/PVP/ZrO₂ was 10/3/57. The glass jar was then placed on a roller mixer to mix for 16 h to form a white viscous slurry for membrane casting.

A polyphenylene sulfide (PPS, PVF Mesh & Screen Technology) mesh was taped on a glass plate. The white slurry was poured on the PPS mesh and casted to form a wet membrane using a casting knife with a knife gap of 10 mil. The wet membrane was immediately soaked in isopropyl alcohol (IPA) for 30 min. Then, the membrane was soaked in deionized (DI) water for 30 min, followed by a second soaking in DI water for 30 min and a third soaking in DI water for 2 h. The membrane was annealed in 80° C. water bath for 30 min and dried at 85° C. in an oven for 1 h.

### Example 2

In a glass jar, 90 g ZrO₂ nanopowder (E101, Luxfer MEL Technologies) was mixed with 56.7 g NMP using overhead mixer for 30 min. After the ZrO₂ powders were fully wetted in NMP, a first batch of 3 g PES was added and stirred for 1 h. The glass jar was placed in a sonication bath and sonicated for 10 min. A second batch of 4 g PES was then added, stirred for 1 h and sonicated for 10 min. A third batch of 3 g PES was then added, stirred for 1 h and sonicated for 10 min. Finally, 3 g PVP was added and stirred for 1 h. The weight ratio of PES/PVP/ZrO₂ was 10/3/90. The glass jar was then placed on a roller mixer to mix for 16 h to form a white viscous slurry for membrane casting.

A PPS mesh was taped on a glass plate. The white slurry was poured on the PPS mesh and casted to form a wet membrane using a casting knife with a knife gap of 10 mil. The wet membrane was immediately soaked in IPA for 30 min. Then, the membrane was soaked in DI water for 30 min, followed by a second soaking in DI water for 30 min and a third soaking in DI water for 2 h. The membrane was annealed in 80° C. water bath for 30 min and dried at 85° C. in an oven for 1 h.

### Example 3

In a glass jar, 90 g ZrO₂ nanopowder (E101, Luxfer MEL Technologies) was mixed with 56.7 g NMP using an overhead mixer for 30 min. After the ZrO₂ powders were fully wetted in NMP, a first batch of 3 g PES was added and stirred for 1 h. The glass jar was placed in a sonication bath and sonicated for 10 min. A second batch of 4 g PES was then added, stirred for 1 h and sonicated for 10 min. A third batch of 3 g PES was then added, stirred for 1 h and sonicated for 10 min. Finally, 4 g PVP was added and stirred for 1 h. The weight ratio of PES/PVP/ZrO₂ was 10/4/90. The glass jar was then placed on a roller mixer to mix for 16 h to form a white viscous slurry for membrane casting.

A PPS mesh was taped on a glass plate. The white slurry was poured on the PPS mesh and casted to form a wet membrane using a casting knife with a knife gap of 10 mil. The wet membrane was immediately soaked in IPA for 30 min. Then, the membrane was soaked in DI water for 30 min, followed by a second soaking in DI water for 30 min and a third soaking in DI water for 2 h. The membrane was annealed in 80° C. water bath for 30 min and dried at 85° C. in oven for 1 h.

### Example 4

In a glass jar, 90 g ZrO₂ nanopowder (E101, Luxfer MEL Technologies) was mixed with 56.7 g NMP using an overhead mixer for 30 min. After the ZrO₂ powders were fully wetted in NMP, a first batch of 3 g PES was added and stirred for 1 h. The glass jar was placed in a sonication batch and sonicated for 10 min. A second batch of 4 g PES was then added, stirred for 1 h and sonicated for 10 min. A third batch of 3 g PES was then added, stirred for 1 h and sonicated for 10 min. Finally, 4 g PVP was added and stirred for 1 h. The weight ratio of PES/PVP/ZrO₂ was 10/4/90. The glass jar was then placed on a roller mixer to mix for 16 h to form a white viscous slurry for membrane casting.

A PPS mesh was taped on a glass plate. The white slurry was poured on the PPS mesh and casted to form a wet membrane using a casting knife with a knife gap of 10 mil. The wet membrane was immediately soaked in DI water for 5 min, followed by a second soaking in DI water for 1 h, a third soaking in DI water for 1 h, and fourth soaking in DI water for 1 h. Then, the membrane was soaked in IPA for 1 h, followed by a second soaking in IPA for 1 h. The membrane was annealed in 80° C. water bath for 30 min and dried at 85° C. in an oven for 1 h.

The water permeance of the membrane was tested using a liquid permeation test unit. The membrane was sealed in a Sterlitech testing vessel, the feed side was filled with DI water and connected to high pressure nitrogen to adjust the feed pressure. The permeated water was collected in a glass jar, which was placed on a scale to measure the weight of water permeated through the membrane in certain time.

The water permeance of the membranes from Examples 1 to 4 is listed in Table 1. Water permeance increased by increasing the concentration of ZrO₂ and/or the concentration of PVP in the slurry for membrane casting. When the wet membrane was soaked in water for phase inversion, the prepared membrane was thicker with more open structure and showed much higher water permeance.

TABLE 1
Water permeance of membranes

| | | Phase | Thick- | |
|---|---|---|---|---|
| | PES/PVP/ZrO₂ | inver- | ness | Permeance |
| Sample | (w/w/w) | sion in | (μm) | (L/(m² · h · bar)) |
| Example 1 | 10:3:57 | IPA | 380 | 405 |
| Example 2 | 10:3:90 | IPA | 340 | 917 |
| Example 3 | 10:4:90 | IPA | 330 | 968 |
| Example 4 | 10:4:90 | H₂O | 420 | 1503 |

### Example 5

In a glass jar, 70 g ZrO₂ nanopowder (E101, Luxfer MEL Technologies) was mixed with 56.7 g NMP using an overhead mixer for 30 min. After the ZrO₂ powders were fully wetted in NMP, a first batch of 3 g PES was added and stirred for 1 h. The glass jar was placed in a sonication batch and sonicated for 10 min. A second batch of 4 g PES was then added, stirred for 1 h and sonicated for 10 min. A third batch of 3 g PES was then added, stirred for 1 h and sonicated for 10 min. Finally, 4 g PVP was added and stirred for 1 h. The weight ratio of PES/PVP/ZrO₂ was 10/4/70. The glass jar was then placed on a roller mixer to mix for 16 h to form a white viscous slurry for membrane casting.

A PPS mesh was taped on a glass plate. The white slurry was poured on the PPS mesh and casted to form a wet membrane using a casting knife with a knife gap of 10 mil. The wet membrane was immediately soaked in DI water for 5 min, followed by a second soaking in DI water for 1 h, a third soaking in DI water for 1 h, and a fourth soaking in DI water for 1 h. Then, the membrane was soaked in IPA for 1 h followed by a second soaking in IPA for 1 h. The membrane was annealed in 80° C. water bath for 30 min and dried at 85° C. in an oven for 1 h.

The ionic resistance of the membrane was measured using a flow battery test cell (Fuel Cell Store) with 30% KOH as an electrolyte solution. The membrane was sealed between two gaskets, and the testing area was 5 cm². Both sides of the membrane were filled with KOH solutions and circulated at 30 mL/min. The resistance of the electrolyte without membrane was measured first. Then, the total resistance of the membrane and the electrolyte was measured. The ionic resistance of the membrane equals the total resistance minus the resistance of the electrolyte.

The ionic resistances of the membranes from Examples 1 to 3 and 5 are listed in Table 2. The ionic resistance decreased by increasing the concentration of ZrO₂ and/or the concentration of PVP in the slurry for membrane casting. When the wet membrane was soaked in water for phase inversion, the prepared membrane was thicker with more open structure and showed much lower ionic resistance.

TABLE 2
Ionic resistance of membranes

| | | Phase | Thick- | Testing | Ionic |
|---|---|---|---|---|---|
| | PES/PVP/ZrO₂ | inver- | ness | Temperature | resistance |
| Sample | (w/w/w) | sion in | (μm) | (° C.) | (Ω · cm²) |
| Example 1 | 10:3:57 | IPA | ~380 | 24.3 | 259 |
| Example 2 | 10:3:90 | IPA | ~340 | 24.3 | 160 |
| Example 3 | 10:4:90 | IPA | ~330 | 24.1 | 139 |
| Example 5 | 10:4:70 | H₂O | ~420 | 23.8 | 109 |

### SPECIFIC EMBODIMENTS

While the following is described in conjunction with specific embodiments, it will be understood that this description is intended to illustrate and not limit the scope of the preceding description and the appended claims.

A first embodiment of the invention is a porous ion-permeable asymmetric composite membrane for electrolysis comprising a porous substrate; and a porous asymmetric polymer coating having a first side and a second side, the first side on the porous substrate, the polymer coating comprising a polymer and inorganic particles, the polymer coating having an asymmetric pore distribution with pores having a first size adjacent to the porous substrate and pores having a size smaller than the first size adjacent to the second side; and wherein the porous substrate, the polymer, and the inorganic particles are stable at a pH of 8 or higher. An embodiment of the invention is one, any or all of prior embodiments in this paragraph up through the first embodiment in this paragraph wherein the polymer comprises polyether sulfone, polysulfone, polyvinylidene fluoride, or combinations thereof. An embodiment of the invention is one, any or all of prior embodiments in this paragraph up through the first embodiment in this paragraph wherein the inorganic particles comprise zirconium oxide, iron oxide, nickel oxide, cobalt oxide, copper oxide, manganese oxide, molybdenum oxide, titanium oxide, antimony oxide, or combinations thereof. An embodiment of the invention is one, any or all of prior embodiments in this paragraph up through the first embodiment in this paragraph wherein the inorganic particles comprise zirconium oxide, antimony oxide, or a mixture thereof. An embodiment of the invention is one, any or all of prior embodiments in this paragraph up through the first embodiment in this paragraph wherein the inorganic particles comprise 10 wt % to 90 wt % of the polymer coating. An embodiment of the invention is one, any or all of prior embodiments in this paragraph up through the first embodiment in this paragraph wherein the porous substrate has an air permeance of 0.5 ft³/ft²/min or more and an open area of 20% or more. An embodiment of the invention is one, any or all of prior embodiments in this paragraph up through the first embodiment in this paragraph wherein the porous substrate comprises polyphenylene sulfide, poly(ether ether ketone), polytetrafluoroethylene, polyethylene, polypropylene, copolymer of tetrafluoroethylene and ethylene, copolymer of tetrafluoroethylene and propylene, copolymer of ethylene and propylene, polychlorotrifluoroethylene, or combinations thereof. An embodiment of the invention is one, any or all of prior embodiments in this paragraph up through the first embodiment in this paragraph wherein the porous substrate comprises polyphenylene sulfide or poly(ether ether ketone). An embodiment of the invention is one, any or all of prior embodiments in this paragraph up through the first embodiment in this paragraph wherein the polymer is different from the porous substrate.

A second embodiment of the invention is a method of making a porous ion-permeable asymmetric composite membrane comprising mixing a polymer, inorganic particles, and a solvent, the polymer and the inorganic particles being stable at a pH of 8 or higher to form a membrane casting dope; casting the membrane casting dope on a porous substrate to form a polymer coating on the porous substrate, the polymer coating having an asymmetric pore distribution with pores having a first size adjacent to the porous substrate and pores having a size smaller than the first size adjacent to the second side, the porous substrate being stable at a pH of 8 or higher, the polymer coating on the porous substrate forming a wet membrane; and annealing the wet membrane to form the stable porous ion-permeable asymmetric composite membrane. An embodiment of the invention is one, any or all of prior embodiments in this paragraph up through the second embodiment in this paragraph further comprising drying the porous ion-permeable asymmetric composite membrane after annealing the wet membrane. An embodiment of the invention is one, any or all of prior embodiments in this paragraph up through the second embodiment in this paragraph wherein the porous ion-permeable asymmetric composite membrane is dried at a temperature in a range of 50° C. to 100° C. An embodiment of the invention is one, any or all of prior embodiments in this paragraph up through the second embodiment in this paragraph further comprising removing the solvent from the polymer coating and the porous substrate before annealing the wet membrane. An embodiment of the invention is one, any or all of prior embodiments in this paragraph up through the second embodiment in this paragraph where the wet membrane is annealed in hot water at a temperature in a range of 50° C. to 90° C. An embodiment of the invention is one, any or all of prior embodiments in this paragraph up through the second embodiment in this paragraph wherein the solvent comprises N-methyl-2-pyrrolidone (NMP), dimethylacetamide (DMAc), dimethylformamide (DMF), dimethyl sulfoxide (DMSO), 1,3-dioxolane, acetone, methanol, ethanol, tetrahydrofuran (THF), toluene, n-octane, n-decane, lactic acid, citric acid, isopropanol, or mixtures thereof. An embodiment of the invention is one, any or all of prior embodiments in this paragraph up through the second embodiment in this paragraph wherein the polymer comprises polyether sulfone, polysulfone, polyvinylidene fluoride, or combinations thereof. An embodiment of the invention is one, any or all of prior embodiments in this paragraph up through the second embodiment in this paragraph wherein the inorganic particles comprise zirconium oxide, iron oxide, nickel oxide, cobalt oxide, copper oxide, manganese oxide, molybdenum oxide, titanium oxide, antimony oxide, or combinations thereof. An embodiment of the invention is one, any or all of prior embodiments in this paragraph up through the second embodiment in this paragraph wherein the porous substrate comprises polyphenylene sulfide, poly(ether ether ketone), polytetrafluoroethylene, polyethylene, polypropylene, copolymer of tetrafluoroethylene and ethylene, copolymer of tetrafluoroethylene and propylene, copolymer of ethylene and propylene, polychlorotrifluoroethylene, or combinations thereof. An embodiment of the invention is one, any or all of prior embodiments in this paragraph up through the second embodiment in this paragraph wherein the inorganic particles comprise 10 wt % to 90 wt % of the polymer coating. An embodiment of the invention is one, any or all of prior embodiments in this paragraph up through the second embodiment in this paragraph wherein the polymer is different from the porous substrate.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A porous ion-permeable asymmetric composite membrane for electrolysis comprising:
a porous substrate; and
a porous asymmetric polymer coating having a first side and a second side, the first side on the porous substrate, the polymer coating comprising a polymer and inorganic particles, the polymer coating having an asymmetric pore distribution with pores having a first size adjacent to the porous substrate and pores having a size smaller than the first size adjacent to the second side;
wherein the porous substrate, the polymer, and the inorganic particles are stable at a pH of 8 or higher.

2. The membrane of claim 1 wherein the polymer comprises polyether sulfone, polysulfone, polyvinylidene fluoride, or combinations thereof.

3. The membrane of claim 1 wherein the inorganic particles comprise zirconium oxide, iron oxide, nickel oxide, cobalt oxide, copper oxide, manganese oxide, molybdenum oxide, titanium oxide, antimony oxide, or combinations thereof.

4. The membrane of claim 1 wherein the inorganic particles comprise zirconium oxide, antimony oxide, or a mixture thereof.

5. The membrane of claim 1 wherein the inorganic particles comprise 10 wt % to 90 wt % of the polymer coating.

6. The membrane of claim 1 wherein the porous substrate has an air permeance of 0.5 ft³/ft²/min or more and an open area of 20% or more.

7. The membrane of claim 1 wherein the porous substrate comprises polyphenylene sulfide, poly(ether ether ketone), polytetrafluoroethylene, polyethylene, polypropylene, copolymer of tetrafluoroethylene and ethylene, copolymer of tetrafluoroethylene and propylene, copolymer of ethylene and propylene, polychlorotrifluoroethylene, or combinations thereof.

8. The membrane of claim 1 wherein the porous substrate comprises polyphenylene sulfide or poly(ether ether ketone).

9. The membrane of claim 1 wherein the polymer is different from the porous substrate.

10. A method of making a porous ion-permeable asymmetric composite membrane comprising:
mixing a polymer, inorganic particles, and a solvent, the polymer and the inorganic particles being stable at a pH of 8 or higher to form a membrane casting dope;
casting the membrane casting dope on a porous substrate to form a polymer coating on the porous substrate, the polymer coating having an asymmetric pore distribution with pores having a first size adjacent to the porous substrate and pores having a size smaller than the first size adjacent to the second side, the porous substrate being stable at a pH of 8 or higher, the polymer coating on the porous substrate forming a wet membrane; and
annealing the wet membrane to form the stable porous ion-permeable asymmetric composite membrane.

11. The method of claim 10 further comprising:
drying the porous ion-permeable asymmetric composite membrane after annealing the wet membrane.

12. The method of claim 11 wherein the porous ion-permeable asymmetric composite membrane is dried at a temperature in a range of 50° C. to 100° C.

13. The method of claim 10 further comprising:
removing the solvent from the polymer coating and the porous substrate before annealing the wet membrane.

14. The method of claim 10 where the wet membrane is annealed in hot water at a temperature in a range of 50° C. to 90° C.

15. The method of claim 10 wherein the solvent comprises N-methyl-2-pyrrolidone (NMP), dimethylacetamide (DMAc), dimethylformamide (DMF), dimethyl sulfoxide (DMSO), 1,3-dioxolane, acetone, methanol, ethanol, tetrahydrofuran (THF), toluene, n-octane, n-decane, lactic acid, citric acid, isopropanol, or mixtures thereof.

16. The method of claim 10 wherein the polymer comprises polyether sulfone, polysulfone, polyvinylidene fluoride, or combinations thereof.

17. The method of claim 10 wherein the inorganic particles comprise zirconium oxide, iron oxide, nickel oxide, cobalt oxide, copper oxide, manganese oxide, molybdenum oxide, titanium oxide, antimony oxide, or combinations thereof.

18. The method of claim 10 wherein the porous substrate comprises polyphenylene sulfide, poly(ether ether ketone), polytetrafluoroethylene, polyethylene, polypropylene, copolymer of tetrafluoroethylene and ethylene, copolymer of tetrafluoroethylene and propylene, copolymer of ethylene and propylene, polychlorotrifluoroethylene, or combinations thereof.

19. The method of claim 10 wherein the inorganic particles comprise 10 wt % to 90 wt % of the polymer coating.

20. The method of claim 10 wherein the polymer is different from the porous substrate.
